(19) United States
(12) Patent Application Publication
(10) Pub. No.: US 2010/0161616 A1
(43) Pub. Date: Jun. 24, 2010

(54) SYSTEMS AND METHODS FOR COUPLING STRUCTURED CONTENT WITH UNSTRUCTURED CONTENT

(76) Inventor: Carol Mitchell, Golden, CO (US)

Correspondence Address: Setter Roche LLP, P.O. Box 780, Erie, CO, 80516, US

(21) Appl. No.: 12/639,631

(22) Filed: Dec. 16, 2009

Related U.S. Application Data
(60) Provisional application No. 61/264,361, filed on Nov. 25, 2009.
(60) Provisional application No. 61/122,733, filed on Dec. 16, 2008.

(51) Int. Cl. G06F 17/30

(52) U.S. Cl. 707/741; 707/E17.002; 707/E17.005

(57) ABSTRACT

A method of coupling structured content, such as that found in an enterprise resource planning system, with unstructured content, such as that stored via an electronic content management system, is presented. In the method, mapping information relating at least one type of structured content with indexing data of at least one type of unstructured content is received. The indexing data is configured to facilitate access to the at least one type of unstructured content in a data storage system. The unstructured content is then received, as well as indexing data associated with the unstructured content. Structured content associated with the unstructured content is identified based on the indexing data. The unstructured content is stored in the data storage system. The identified structured content is then linked with the unstructured content stored in the data storage system via the indexing data to allow access to the unstructured content in the data storage system via the identified structured content.

### RELATED APPLICATIONS

This application claims the benefit of U.S. Provisional Application No. 61/122,733, entitled “Integration between Oracle® E-Business Suite Applications and Document Management Solutions, Including Integrating with Invoice Capture Software for the Automatic Creation of an Invoice within Oracle E-Business Suite for the Automatic Creation of Invoices”, and filed Dec. 16, 2008. This application also claims the benefit of U.S. Provisional Application No. 61/264,361, entitled “METHOD AND SYSTEM FOR INTEGRATING AN ENTERPRISE RESOURCE PLANNING (ERP) SYSTEM WITH CONTENT MANAGEMENT (CM) AND CONTENT CAPTURE SYSTEMS”, and filed Nov. 25, 2009. Each of these applications is hereby incorporated herein by reference in its entirety.

### BACKGROUND

Operating a business of nearly any kind typically involves the storage and processing of significant amounts of data. Such data may include inventory information, financial data, employment records, and a plethora of other information. Further, the larger the business is, and the longer the business remains in operation, the more arduous the task of processing and storing such data. In response to this ever-growing challenge, many computing systems and related software have been employed to automate the processing and handling of business data to at least some degree.

One type of software application or computing system in wide use today is the enterprise resource planning (ERP) system. Generally, an ERP system manages the flow of business data stored in a centralized or distributed database through a typical business process, from planning and purchasing, through manufacturing, distribution, and sales, to accounting, payroll, and so on. As a result, within a particular business entity, various functional groups, including but not limited to supply chain management, human resources, manufacturing, sales, and accounting, may access the same ERP system. An overarching term for the type of transactional data employed in such a system is “structured content”. Such content has been parsed and/or classified into various types or fields for use in an ERP system, with each type of data normally adhering to a particular format or scheme. One well-known type of ERP system is the Oracle® E-Business Suite (EBS) by Oracle Corporation.

Another type of computing system or software application employed in the business world is the Enterprise Content Management (ECM) system or, alternatively, the Document Management System (DMS). In contrast to an ERP system, an ECM system acts as a repository for storing, managing, and retrieving “unstructured content”. Generally speaking, unstructured content has not been parsed or classified to any significant extent, and thus cannot be adequately processed or utilized in an ERP system. One example of unstructured content is a digitized or scanned copy of a paper document. Another example is an electronic document, such as that generated from a word processing application, spreadsheet program, e-mail package, computer-aided design (CAD) application, or the like. Examples of ECM systems include IBM® FileNet® P8 by IBM Corporation, the Oracle® ECM Suite by Oracle Corporation, and OnBase® by Hyland Software Inc.

Quite often, a content capture (CC) system is utilized to provide unstructured content to an ECM system. For example, a CC system may scan and convert paper documents into electronic image files representing the unstructured content. In addition, the CC system may collect indexing data or metadata, either from a user or from the unstructured content itself, for describing and storing the image file in the ECM system for subsequent access or retrieval. A CC system may also provide mechanisms for importing and indexing unstructured content from electronic documents, such those discussed above, for storage in the ECM system. Examples of a CC system include Kofax® Capture and Kofax® Transformation Modules by Kofax plc, OCR for AnyDoc® by AnyDoc® Software, Inc., and the EMU® Captiva® Capture Application Suite by EMC Corporation.

Oftentimes, one or more structured data records within a company's ERP system is related in some fashion to specific unstructured data records or files stored in a related ECM system. For example, a company employee may be related to both the employee record held in the ERP system and the employee's resume stored in the ECM system. In some ERP systems, attachment of the resume to the employee ERP record to facilitate access to the resume from within the ERP system is possible. This sort of attachment must generally be performed manually by a user. Further, by storing the image of the resume and similar unstructured content in the ERP system, the size of the data in the ERP system may increase significantly. Additionally, functions normally associated with the ECM system, such as version control, enforcement of corporate records retention rules, support of legal discovery activities, and access control, are limited or lost with respect to the attached document.

### BRIEF DESCRIPTION OF THE DRAWINGS

Many aspects of the present disclosure may be better understood with reference to the following drawings. The components in the drawings are not necessarily depicted to scale, as emphasis is instead placed upon clear illustration of the principles of the disclosure. Moreover, in the drawings, like reference numerals designate corresponding parts throughout the several views. Also, while several embodiments are described in connection with these drawings, the disclosure is not limited to the embodiments disclosed herein. On the contrary, the intent is to cover all alternatives, modifications, and equivalents.

FIG. 1 is a simplified block diagram of a data processing system incorporating an integration system for coupling structured content and unstructured content systems according to an embodiment of the invention.

FIG. 2 is a flow diagram of a method according to an embodiment of the invention of coupling structured content with unstructured content within the environment of FIG. 1.

FIG. 3 is a block diagram of a data processing system incorporating an integration system coupling an enterprise resource planning system with an enterprise content management system and a content capture system according to an embodiment of the invention.

FIG. 4 is a flow diagram of a method of installing, configuring, utilizing, and maintaining the integration system of FIG. 3 according to an embodiment of the invention.

### DETAILED DESCRIPTION

The enclosed drawings and the following description depict specific embodiments of the invention to teach those skilled in the art how to make and use the best mode of the invention. For the purpose of teaching inventive principles, some conventional aspects have been simplified or omitted. Those skilled in the art will appreciate variations of these embodiments that fall within the scope of the invention. Those skilled in the art will also appreciate that the features described below can be combined in various ways to form multiple embodiments of the invention. As a result, the invention is not limited to the specific embodiments described below, but only by the claims and their equivalents.

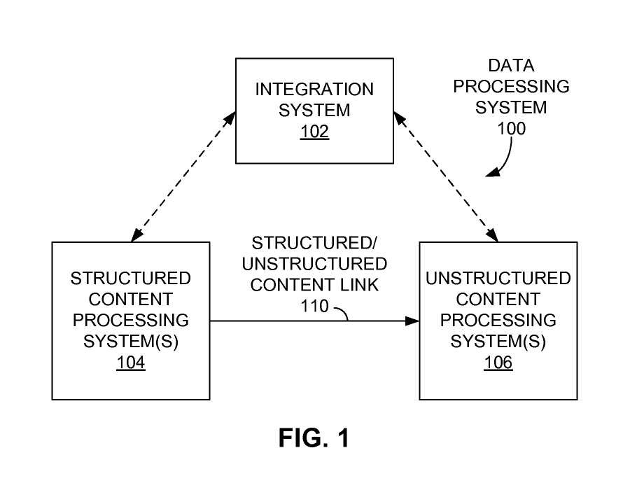

FIG. 1 is a simplified block diagram of a data processing system including an integration system 102 configured to coupling one or more structured content processing systems 104 with one or more unstructured content processing systems 106 by facilitating a link 110 between structured content and unstructured content as provided in the two types of systems 104, 106. As noted above, structured content is content or data that has been parsed and/or classified into various types or fields for use in an enterprise resource planning (ERP) system, while unstructured content has not been so processed, and thus is not suitable for processing or utilization in an ERP system. As a result, in one embodiment, an example of the structured content processing system 104 is an ERP system, while an example of the unstructured content processing system 106 is an ECM system, possibly including a CC system, as these are described above.

In the example of FIG. 1, the systems referenced therein may be separate computing systems, or may be software packages or sets of modules residing on the same or different computing platforms. In other implementations, portions of the integration system 102 may be distributed among the computing systems associated with the structured content processing system 104 and the unstructured content processing system 106. More generally, each of the integration system 102 and the content processing systems 104, 106 may not be loaded onto separate computing systems, but may be located on any one or more computing systems, with portions of one system 102, 104, 106 being loaded onto a computing platform containing portions of another system 102, 104, 106.

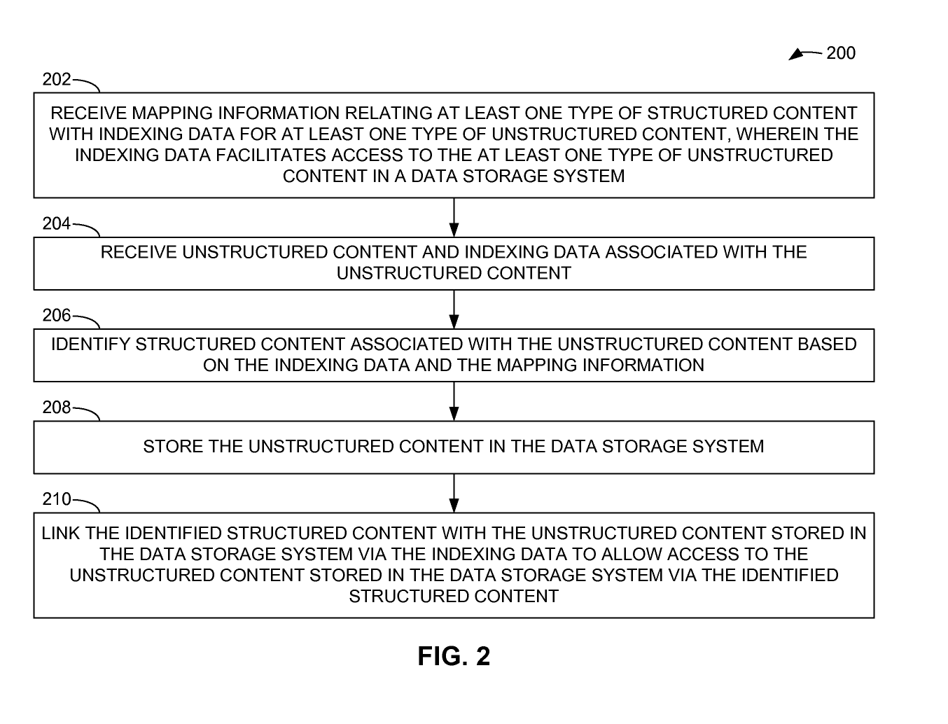

FIG. 2 presents a method 200 of coupling structured content with unstructured content. One such system for employing the method 200 may be the integration system 102 of FIG. 1, although other systems may be capable of performing the method 200 operations as well. In the method 200, mapping information relating at least one type of structured content with indexing data for at least one type of unstructured content is received (operation 202). Such indexing data is configured to facilitate access to the at least one type of unstructured content in a data storage system, such as a data storage system included in, or associated with, the unstructured content processing system 106. Unstructured content is then received, as is indexing data associated with the unstructured content (operation 204). Structured content, such as that employed in the structured content processing system 104, that is associated with the unstructured content is identified based on the indexing data and the mapping information (operation 206). The unstructured content is stored in the data storage system (operation 208). The identified structured content is then linked with the unstructured content stored in the data storage system via the indexing data to allow access to the unstructured content via the identified structured content (operation 210).

While the operations of FIG. 2 are depicted as being executed in a particular order, other orders of execution, including concurrent or overlapping execution of two or more operations, may be possible. For example, the unstructured content may be stored in the data storage system prior to identifying the structured content associated with the unstructured content in some implementations.

In other embodiments, a computer-readable storage medium may have encoded thereon instructions for execution on one or more computer processors or other control circuitry to implement the method 200 of FIG. 2. Further, one or more computing systems configured to execute such instructions for employing the method 200 may represent more embodiments.

The method 200, as well as any computer-readable medium, computing system, or software system, such as the integration system 102 of FIG. 1, may thus allow access to unstructured content in an unstructured content processing system 106 via a structured content processing system 104 by way of linking the two types of content in a primarily automatic fashion. As a result, the unstructured content may remain within the control of the unstructured content processing system 106, thus allowing the system 104 functions regarding version control, records retention policies, and the like to apply to the unstructured content. Meanwhile, access to the unstructured content via the structured content processing system 104 and its records is provided in an automated manner without requiring an extra copy of the unstructured content to be placed within the care of the structured content processing system 104. Additional advantages may be recognized from the various implementations of the invention discussed in greater detail below.

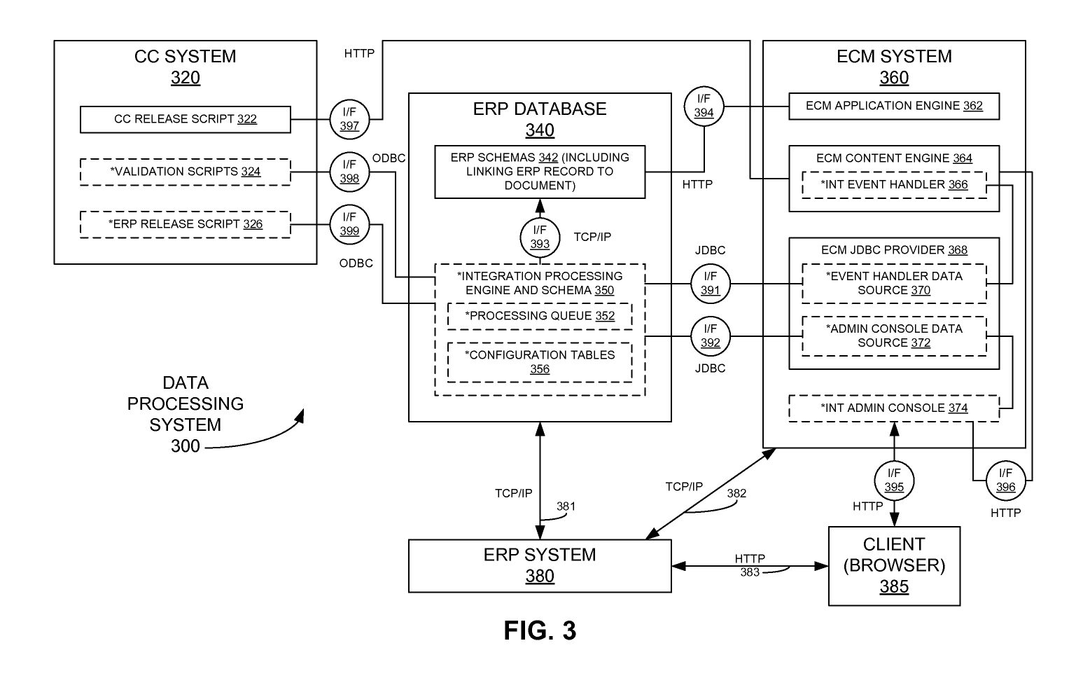

FIG. 3 provides a block diagram of a data processing system 300 according to a more detailed embodiment of the invention. As shown in FIG. 3, the data processing system 300 includes a content capture (CC) system 320, an enterprise resource planning (ERP) system 380 and its associated ERP database 340, an enterprise content management (ECM) system 360, and a client system 385 running a web browser or similar communication program. In this specific example, each of the CC system 320, the ERP system 380, the ERP database 340, and ECM system 360 reside on separate computing systems, although such an arrangement is not required in other implementations. Each of the computing systems may incorporate functional components normally associated with such systems, including one or more processors employing an operating system, memory units, data storage devices, input/output interfaces, and so on. The systems may also be communicatively coupled by any one or more communication networks or links, such as local-area networks (LANs), including Ethernet and/or other possible network connections, and wide-area networks (WANs), such as the Internet.

As depicted in FIG. 3, the client system 385 may communicate with the ERP system 380 through its web browser via a HyperText Transfer Protocol (HTTP) connection 383, while the ERP system 380 may communicate with its ERP database 340 and the ECM system 360 via Transmission Control Protocol/Internet Protocol (TCP/IP). However, other types of communication links and protocols may be utilized to provide these communicative connections in other examples.

Generally, each of the CC system 320, the ERP system 380, the ERP database 340, and the ECM system 380 operate substantially as described above. In one specific example, the ERP system 380 and associated database 340 may include the Oracle® E-Business Suite (EBS) by Oracle Corporation. Further, the CC system 320 may include the Kofax® Capture and Kofax® Transformation Modules by Kofax plc, while the ECM system 360 includes IBM® FileNet® P8 by IBM Corporation. However, other types and combinations of ERP, CC, and ECM systems may be employed in other embodiments.

As indicated in FIG. 3, software modules of the integration system for coupling together the CC system 320, the ERP system 380 (via its database 340), and the ECM system 360 are distributed throughout the computing platforms executing the other systems 320, 340, 360 of the overall processing system 300. Such an arrangement may limit the amount of inter-computer translation and communication required, although arrangements other than that specifically illustrated in FIG. 3 may be utilized. In FIG. 3, each of the software modules or sections associated with the integration system are identified by an asterisk in the module description, and by a dashed border. The other modules denoted in FIG. 3 are portions of the various systems 320, 340, 360 that communicate with the integration system; still other portions of the CC system 320, the ERP database 340, and the ECM system 360 are not shown in FIG. 3 nor described further below to simplify and focus the following discussion regarding the integration system.

In the specific example of FIG. 3, included in the integration system is an administrative console 374 embodied as a web application loaded into an application server, such as the WebSphere Application Server by IBM Corporation, or the Oracle® WebLogic Server by Oracle Corporation, which may reside on the ECM system 360 or the ERP database 340. The console 384 thus may be accessed via a web browser, such as that employed in the client 385, via an HTTP interface 395. Generally, the console 374 allows an administrator or other user to configure and maintain most features and functions of the integration system. For example, the console 374 may allow a system administrator or similar supervisory user to define and maintain user accounts and associated roles within the integration system. In one implementation, several different types or levels of user accounts may exist. One user account type may be a “system administrator” account, which allows the user to view, define, and maintain other user accounts, as well as maintain database connection configurations (such as host names, IP addresses, port numbers, and the like) between the ERP system 340 and the ECM system 360, as well as database properties (retry notification e-mail server and associated addresses, integration system license system, and so forth).

Another account type may be a “mapping administrator” account, allowing the user to view, define, and maintain data field mapping between the ERP system 340 and the ECM system 360 to support the creation of new document types that may be linked to the ERP system 380 application. In yet another account type, an “exception administrator” account may allow a user to view exceptions, generate reports on the exceptions, and attempt reprocessing of currently outstanding exceptions. More information regarding mapping and exceptions is provided below. The console 374 may also allow each administrative user to view and edit their user profiles related to the integration system.

In one embodiment, the data regarding the user accounts, configurations, and other data that may be modified by the console 374 may be stored in an administrative console data source 372 within an ECM JDBC (Java™ Database Connectivity) provider 368. In turn, the console data source 372 may be coupled with an integration system processing engine 350 by way of a JDBC connection 391. Thus, the console 374 may have access to the schema of the processing engine 350, such as a processing queue 352 and configuration tables 356, each of which is addressed more completely below.

As noted above, importation of unstructured content may be performed by way of a content capture system, such as the CC system 320 of FIG. 3. The CC system 320 extracts indexing data (metadata) from the unstructured content, such as by way of optical character recognition of image data that has been scanned. To aid in providing links between structured content of the ERP database 340 and the unstructured content being processed in the CC system 320, one or more of a set of integration system validation scripts 324 provide the extracted indexing data to the integration processing engine 350 loaded in the ERP database 340, which is employed to compare the extracted indexing data against structured content stored in the ERP database 340. As shown in FIG. 3, the indexing data is provided by the validation scripts via an ODBC (Open Database Connectivity) connection 398 to the processing engine 350. In response, the processing engine 350 may inform the CC system 320 of any matches, as well as mismatches or invalid data, found in the indexing data when compared to matching structured content records in the ERP database 340.

Based on the results of the validation, the indexing data may remain the same, or may be modified to synchronize the indexing data associated with the unstructured content in the CC system 320. Further, the CC system 320 may employ its own release script 322 to transfer the unstructured content and associated indexing data via an HTTP interface 397 to an ECM content engine 364 of the ECM system 360, which employs the indexing data for storage and subsequent retrieval of the unstructured content record.

Instead of scanning in paper documents, or importing electronic documents, via the CC system 320, the integration system may deploy an ingestion service (not shown in FIG. 3) within, or in lieu of, the CC system 320 to load unstructured content records to the ECM system 360. More specifically, the ingestion service may perform bulk upload operations, as well as facilitate uploads from shared network directories, of electronic documents, such as word processing documents, spreadsheet documents, e-mail messages, and the like. For example, the ingestion service may support data conversion and migration from legacy ECM systems with bulk upload capabilities, and automatically search or “sweep” the resulting unstructured content for uploading to the CM system 360 at a shared network location.

The integration processing engine 350 and associated schema, executed from the ERP database system 340 as shown in FIG. 3, is capable of performing a number of functions associated with the linking of structured and unstructured content records. In one example, the processing engine 350, when used in conjunction with the CC system 320, may compare document indexing data or metadata captured by the CC system, by optical character recognition (OCR), manual data entry, or otherwise, against ERP database 340 records for validity. This functionality allows the processing engine 350 to identify currently existing structured content records in the ERP database 340 which correspond with the unstructured content associated with the received indexing data. This functionality is guided via mapping data stored in the configuration tables 356 which indicate which data fields of particular types of structured content records correspond with which portions of the indexing data for types of unstructured content records. The processing engine 350 then alerts the CC system 320 as to records, and possibly associated data fields thereof, that match the received indexing data or metadata, as well as those which do not match the indexing data. The processing engine 350 may also indicate which indexing data or metadata appear to be invalid.

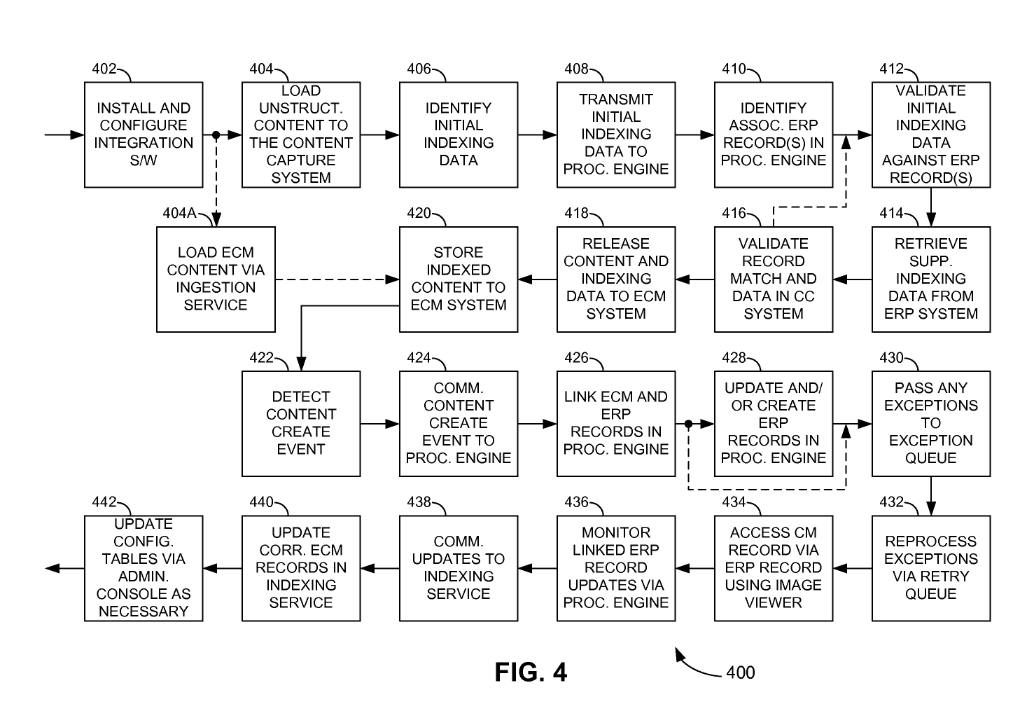

Further, the processing engine 350 may create and delete links between the structured data of the ERP database 340 and the unstructured data stored in the ECM system 360 when the corresponding unstructured content records are added or deleted in the ECM system 360. In one implementation, such links may take advantage of document attachment functionality provided in the ERP system 380, such as a link associated with or included in the associated structured data record in the ERP database 340. The linking process is described more fully with respect to the workflow example depicted in FIG. 4.

In another embodiment, the processing engine 350 may create additional ERP structured data records associated with other structured and unstructured data records already present in the system. For example, the processing engine 350 may receive indexing data extracted from unstructured content received in the CC system 320 via an ERP release script 326 through another ODBC connection 399, coupled with additional data retrieved from an ERP structured content record in the ERP database 340, process the data, and transfer the resulting data to an ERP API (Application Programming Interface) to create the new structured data record. The processing engine 350 may also associate the new structured content record with the previously existing structured content record.

As indicated above, the actions taken by the processing engine 350, such as during link creation, the generation of new structured content records, the validation of indexing data retrieved during unstructured content capture, and the like, typically require the processing engine 350 to access the ERP schemas 342 and associated data. Such communication takes place in FIG. 3 via an internal TCP/IP interface 393 coupling the processing engine 350 with the ERP schemas 342 and data. In some examples, the processing engine 350 may update or revise data in “staging tables”, which are tables serving as entry points for data to be stored in records of the ERP database 340.

An integration event handler 366, which may also be termed an “event action service”, is installed on the ECM system 360 in the embodiment of FIG. 3. The event handler 366 is configured to invoke the processing engine 350 by way of a message transmitted via an event handler data source 370 of the ECM JDBC provider 368 and a JDBC interface 391. Generally, the event handler 366 monitors events originating in the ECM system 360 concerning the creation, deletion, and modification of unstructured documents, and in response, invokes the processing engine 350 to resynchronize document metadata in the structured content records of the ERP database 340, to generate new structured content records, and to establish, update, or delete links between structured and unstructured content records.

In FIG. 3, the event handler 366 invokes the processing engine 350 by placing a message related to a particular task to be performed in a processing queue 352, located with the processing engine 350 in the ERP database 340. As indicated above, such tasks may include the establishment of links between structured and unstructured content records, the updating of preexisting structured content records, and the creation of new structured content records, as mentioned above.

Within the console 374, an indexing service may be employed to facilitate the updating or synchronization of indexing data stored in conjunction with unstructured content records located in the ECM system 360. More specifically, when structured content records in the ERP database 340 are updated, and those updates affect indexing data associated with unstructured content in the ECM system 360 to which the structured content records are linked, the indexing service identifies such changes and updates the corresponding indexing data (metadata) for the affected unstructured content records in the ECM system 360. The indexing service may undertake such actions periodically, such as once every night, to ensure the structured content records and their related unstructured content records remain synchronized. The console 374 may undertake these updates via an HTTP interface 396 coupling the console 374 with the ECM content engine 364.

When a link is established between at least one structured content record and at least one unstructured content record, a user of the client 385 accessing the structured content record via the ERP system 380 may open and view an image of the linked unstructured content record in the ECM system 360 from the structured content record by way of a HTML link (“hyperlink”) or similar construct, thus invoking an image viewer normally provided by the ECM system 360. Thus, all features typically associated with the viewer would be available to the user with respect to the unstructured content being perused. As shown in FIG. 3, communication for providing the link may be provided by way of an HTTP interface 394 coupling the ERP schemas 342 with the ECM content engine 364.

Additionally, integration system software located within the ERP database 340, which may be incorporated as part of the processing engine 350, may facilitate the storage in the ECM system 360 of reports generated via the ERP system 380. Data in the configuration tables 356 or other configuration data structures may define where within the ECM system 360 the report should be stored, which users should be granted access to the report, and other pertinent information. Further, employing processes typically provided in an ERP system 380 for notifying other users, a message, such as an e-mail message, may be sent to the selected users to notify the users that the report is available. Moreover, the notification may provide a link which the users may activate to view the report as stored in the ECM system 360.

At times, the processing of a task in the processing engine 350 is unsuccessful. For example, in response to a new unstructured content record being transferred into the ECM system 360, the processing engine 350 may attempt to locate a related structured content record in the ERP database 340, only to find that such a record does not exist. In response, the processing engine 350 may generate an exception that is loaded into an exception queue (not explicitly shown in FIG. 3) associated with the console 374. An administrator accessing the exception queue may then view that (and any other) exceptions stored in the exception queue, generate reports concerning those exceptions, and cause the processing engine 350 to reprocess any of the exceptions.

Further, the reprocessing of an exception may be initiated by way of loading the exception into a retry queue (also not shown in FIG. 3) associated with the console 374. In this case, a user may cause an exception to be reprocessed by causing the console 374 to place the task in the retry queue. The task may then be transferred as a message from the retry queue to the processing queue 352 by way of another JDBC interface 392 coupling the ECM system 360 with the ERP database 340. Alternatively, the configuration tables 356 or similar configuration data may indicate that all (or certain types of) exceptions encountered in the processing engine 350 may be automatically retried. In response, the failed task may be transferred to the retry queue for reprocessing. In addition, the configuration data controlling the retry function may set limits on the retry mechanism, such as a time limit or a retry attempt limit, after which an administrator may need to intervene via the console 374 to initiate any more retry attempts.

Given the basic configuration provided in FIG. 3 and associated functionality as described above, the flow of operation of the integration system, from initial system installation and configuration, through system updating and maintenance, is illustrated via a flow diagram 400 presented in FIG. 4. In the following discussion, an incoming paper (or electronic) invoice being introduced to the data processing system 300 as unstructured content, and the linking of structured content associated with a previously generated purchase order, is described. However, as mentioned earlier, other types of documents normally associated with any business function may be processed using substantially the same set of operations discussed hereinafter.

Before any processing is to be performed, the integration system is installed and configured on the one or more computer systems to be employed in the data processing system 300 (operation 402). Generally, the integration system is installed after the CC system 320, ERP system 380 and associated database 340, and the ECM system 360 have been installed. More specifically, the various software modules or components of the integration system are physically installed on the hardware computing system components employed for the other systems 320, 340, 360, 380. Generally, each of these systems 320, 340, 360, 380 is then configured, after which at least some of the software components of the integration system are configured, primarily via the administrative console 374 residing in an application server, such as WebSphere or WebLogic, as described above, on either the ECM system 360 or the ERP system 380. At least part of the data used to configure the integration system resides in the configuration tables 356 associated with the processing engine 350. The configuration data may include, but is not limited to, data defining how the integration system interfaces with each of the other systems 320, 340, 360, 380 of the overall processing system 300, the types and formats of the structured data records of the ERP database 340, the types and formats of the indexing data associated with the unstructured data records of the ECM system 360, the data regulating when and how processing exceptions are handled, and the profile data for each of the users expected to utilize the integration system.

More specifically, the configuration tables 356 include mapping data (mentioned above), which describes which fields or “keys” of a particular structured content record type correspond with which fields or “properties” of a specific unstructured content type. For example, via the console 374, particular fields, such as vendor ID, purchase order or invoice number, employee ID, item number, item cost, and the like, available in a purchase order or invoice record in the ERP database 340 may be selected by a mapping administrator. Similarly, corresponding indexing data fields for an invoice document image may be selected as well. The administrator may then correlate or associate each of the selected fields of the ERP database 340 purchase order or invoice record type with the corresponding indexing data field of the ECM system 360 invoice document type. The processing engine 350 later employs the mapping information to validate or generate indexing data, create links between structured and unstructured content records, and so on, as discussed below. After all installation and configuration is completed, testing of the entire system 300 using sample structured and unstructured content may be performed.

Once the various portions of the processing system 300 are installed and configured, unstructured content may be loaded to the CC system 320 (operation 404). As discussed earlier, the unstructured content may be loaded by way of scanning of paper documents, or the importing of electronic documents, to generate corresponding image files or records.

In one implementation, an alternative method for the loading of unstructured content may be performed by the ingestion service described above. The ingestion service may perform bulk uploads of paper and/or electronic documents, and uploads from shared network directories containing multiple electronic documents, such as text and document files, spreadsheets, e-mails, and so on. Additionally, the ingestion service may support various types of data conversion/migration from legacy ECM systems that are incompatible with the ECM system 360 of FIG. 3. When the ingestion of previously indexed unstructured content occurs, some or all of the subsequent extraction and validation of indexing data associated with the ingested unstructured content, as discussed below involving operations 406-420, may be circumvented.

After new unstructured data has been loaded to the CC system 320 (operation 404), initial indexing data is identified and extracted from the unstructured content (operation 406). In one implementation, the CC system 320 may consult configuration data, such as that found in the configuration tables 356, that indicate the salient portions of the captured document that contain relevant indexing data, as well as the expected format of the indexing data residing in those areas. The CC system 320 may then retrieve or extract that initial indexing data from the unstructured content based on that configuration data. This initial indexing data is then transferred to the processing engine 350 (operation 408). In one example, the validation scripts 324 installed in the CC system 320 transfer the indexing data via the ODBC interface 398 to the processing engine 350. With respect to an invoice, the indexing data may include, for example, an invoice number, a vendor name and/or number, an invoice date, an invoice amount, a purchase order number, and the like.

In response to receiving the initial indexing data, the processing engine 350 identifies one or more ERP structured records in the ERP database 340 that correspond with the initial indexing data (operation 410). In the example of FIG. 3, the processing engine 350 accesses the structured records via the internal TCP/IP interface 393 coupling the processing engine 350 with the ERP schemas 342 and data to perform a lookup action in the ERP database 340. Additionally, the processing engine 350 may employ information in the configuration tables 356 to determine which portions of which ERP structured content records are to be compared with the initial indexing data. In the invoice example, the identified structured record may represent pertinent data from the purchase order that is associated with the incoming invoice.

The processing engine 350 then compares the relevant portions of the identified ERP structured content record (or records) with the initial indexing data to validate the initial indexing data (operation 412). In one implementation, the processing engine 350 performs this comparison according to data in the configuration tables 356, which may indicate which indexing data values are to be compared against which fields of the identified structured field records, and may also indicate which comparisons between the structured record fields and the indexing data values constitute matches or mismatches. In the example of the invoice and related purchase order record, the configuration data may direct the processing engine 350 to compare a corresponding invoice number, a vendor name and/or number, an invoice date, an invoice amount, a purchase order number, and the like of the purchase order and the invoice.

In addition to the validation operation (operation 412), the processing engine 350 may collect additional indexing data from the identified ERP structured content records via the internal interface 393 and transfer the data to the CC system 320 (operation 414). Such data collection may also be directed via the configuration tables 356 in the ERP database 340. In the invoice example, the additional indexing data may be data from other fields of the purchase order record associated with the incoming invoice. As a result, this additional information may thus allow a user to search for the invoice document directly in the ECM system 360 using this additional field data.

After receiving the additional indexing data (if any is available), the CC system 320 attempts to validate either or both of the ERP structured content records identified by the processing engine 350 and the data fields used as matching data against the initial indexing data and any additional indexing values (operation 416). Again, the CC system 320 may perform such validation in view of configuration data in the configuration tables 356 or elsewhere in the data processing system 300. In one implementation, the process involves a human operator or administrator of the CC system 420 by displaying the results of one or both of the validation of the initial indexing data (operation 412) and the subsequent retrieval and transmission the additional indexing data (operation 414) to the user, and inviting the user to confirm or correct the results of the CC validation operation. In one implementation, if any updates to the indexing data are made, the indexing data may be transferred once again to the processing engine 350 to perform either or both of the index validation operation (operation 412) and retrieval operation (operation 414) noted above.

Once validation of the initial and any additional indexing data is complete, the CC system 320, by way of its CC release script 322, releases the unstructured content and associated indexing data to the ECM system 360 (operation 418). In the invoice example, this data would represent the unstructured content, such as an image of the invoice, and any indexing data associated therewith. This data may be transferred via the HTTP interface 397 coupling the CC release script 322 with the ECM content engine 364 of the ECM system 360. Additionally, as mentioned above, the resulting indexing data may be transferred to the processing engine 350 from the ERP release script 326 via the ODBC interface 399 for possible generation of new structured content records. In the specific example of an incoming invoice, the processing engine 350 may initiate the generation of an invoice structured content record in the ERP database 340, and link the new record with the unstructured content record representing the invoice.

In response to receiving the unstructured content and corresponding indexing data, the ECM content engine 362 stores the content in the ECM system 360 using the indexing data (operation 420). This storage may also be directed by configuration data, such as that supplied in the configuration tables 356, supplied as part of the configuration process for the integration system (operation 402) described earlier.

The storage of the unstructured content by the ECM content engine 362 constitutes an event that is detected at the integration system event handler 366 stored in the ECM system 360 (operation 422). Depending on the implementation, the event handler 366 may detect the event by constantly or periodically monitoring events in the ECM system 360, via an interrupt or other signaling scheme, or by some other communication method. In response to detecting the storage event, the event handler 366 informs the processing engine 350 in the ERP database 340 of the event via the event handler data source 370 and the JDBC interface 391 (operation 424). This communication may take the form of a message that includes the document indexing data or metadata associated with the stored unstructured content, as well as link data, such as an HTML link, to the content as stored in the ECM system 360. In the example of FIG. 3, the message is stored in the processing queue 352 to await processing by the processing engine 350.

When processing the message, the processing engine 350 links the unstructured content to the identified structured content record located in the ERP database 340 (operation 426). As noted above, the link data generated in the ECM system 360 may be included in, or otherwise associated with, the structured content record. In one example, the link is established by using an attachment functionality provided in the ERP database 340 to logically attach the unstructured content record stored in the ECM system 360 (e.g., the invoice) to the structured content in the ERP database 340 (e.g., the purchase order record). As before, the processing engine 350 employs the internal interface 393 to access the ERP schemas 342 to perform the necessary operations on the structured content record. As a result, user access to the structured content record (e.g., the preexisting purchase order record, and possibly a newer invoice record) will allow the user to access the associated unstructured content record (e.g., an image of the invoice) in the ECM system 360 without having to resort to searching for the unstructured content via the ECM application engine 362 directly. As noted above, such access may be provided via a hyperlink or other communication construct associated with the structured content to allow the user to invoke an image viewer of the ECM system 360 to view an image of the unstructured content.

In some implementations, the processing engine 350 may update current ERP structured content records, and/or create new such records, based on additional indexing data received as a result of new content being added by the CC system 320 or ingesting service to the ECM system 360 (operation 428). For example, the processing engine 350 may update a current ERP record if the indexing data associated with the new unstructured content match data in corresponding fields of the current structured record. As indicated in FIG. 3, the indexing data associated with the content being stored to the ECM system 360 may be received at the processing engine 350 from the ERP release script 326 via the ODBC interface 399. In response, the processing engine 350 may search for a preexisting ERP record in the ERP database 340 using the indexing data, and update the record using at least some of the indexing data. For instance, in the invoice example, the purchase order record may be updated with the received indexing data. In other situations, depending on the information stored in the configuration tables 356, the processing engine 350 may instead generate a new ERP record, such as a new structured content record for the incoming invoice, using the received indexing data.

At times, the processing engine 350 may not be able to complete its assigned task, as received in a message through the processing queue 352. In the invoice example, a preexisting purchase order record may not be stored in the ERP database 340. As a result, the processing engine 350 generates an exception, and places the exception in the exception queue (operation 430). A user may have access to the exception queue via the console 374, whereby the user may view the exceptions, and generate reports detailing the exceptions. Further, the user may attempt reprocessing of the exceptions by the processing engine 350 by placing the task in the retry queue via the console 374 (operation 432). Under some circumstances, the exceptions may be placed automatically from the exception queue to the retry queue based on the configuration tables 356 as set up through the console 374. A user may also view the exceptions and generate reports of the exceptions residing in the retry queue via the console 374.

When a user accesses a structured content record (such as the purchase order record noted above) in the ERP database 340, the user may also access the previously linked unstructured content record (i.e., the associated invoice) by way of an image viewer provided by the ECM system 360 (operation 434). In one example, the unstructured content is linked by way of document attachment functionality provided in the ERP system 380, such as the attachment function provided in the Oracle EBS. Further, the processing engine 350 may modify the structured content record to enable the use of the attachment function via data in the configuration tables 356. This attachment functionality may also be accessible by way of notifications from the ERP system 380, such as e-mail messages, which notify the recipient of the incoming content (such as the invoice noted earlier) and which may also present an HTML link or similar connection mechanism to the unstructured content via the ECM system 360 image viewer.

In addition, for links that have been established between structured and unstructured data records, the processing engine 350 may also monitor those structured content records for updates that may affect the link (operation 436). When such relevant field updates have occurred, the processing engine 350 may communicate pertinent information regarding the update to the indexing service of the administrative console 374 (operation 438). As a result of this information, the indexing service may then update the indexing data associated with the unstructured content stored in the ECM system 360 (operation 440), such as by way of the HTTP interface 396 to the ECM content engine 364.

At various times throughout the operation of the data processing system 300, an administrator or other user may periodically maintain and/or update various aspects of the system 300 (operation 442). For instance, as various processes and requirements of the associated business evolve over time, the administrator may employ the console 374 to access and change data within the configuration tables 356 to adapt various aspects of the integration system to changes in the format of various types of structured data records in the ERP database 340, the addition of new types of structured data records, and the deletion of other types of structured data records. As each of these changes is made, the processing engine 350 may be tasked with the modification of links in the structured content records to unstructured records in the ECM system 360, as discussed in greater detail above.

At least some embodiments as described herein thus allow the integration of two important data processing systems often employed in a single business entity: an enterprise content management (ECM) system (possibly coupled with a content capture (CC) system) and an enterprise resource planning (ERP) system or database. More specifically, such integration provides the ability to establish links automatically between structured content records of the ERP system and the unstructured content records, such as document images, of the ECM system. As a result, portions of a business process that may require interaction with business personnel, such as approval or further data input regarding a document or record, may be expedited by making all relevant information available to the personnel via the ERP system without requiring the personnel to access both the ERP and ECM systems explicitly. Also, the use of such links eliminates any need to store the unstructured content in the ERP system, thus leaving all copies of the unstructured content in the ECM system, resulting in the application of all document retention, revision control, discovery process, and other corporate policies regarding image document handling that are implemented in the ECM system to encompass all existing document copies. In addition, the possible enhancement or augmentation of indexing information associated with an unstructured content document may allow a user of the ECM system to search for documents using more or different search terms or data than what is ordinarily possible.

While several embodiments of the invention have been discussed herein, other implementations encompassed by the scope of the invention are possible. For example, while various embodiments have been described within the context of data processing of information associated with a business, including the use of ERP and ECM systems, other entities, such as governmental, trade, or charitable organizations, that generate, receive, and/or process structured and unstructured content may employ various aspects of the systems and methods described above. In addition, aspects of one embodiment disclosed herein may be combined with those of alternative embodiments to create further implementations of the present invention. Thus, while the present invention has been described in the context of specific embodiments, such descriptions are provided for illustration and not limitation. Accordingly, the proper scope of the present invention is delimited only by the following claims and their equivalents.

What is claimed is:

1. A method of coupling structured content with unstructured content, the method comprising:
receiving mapping information relating at least one type of structured content with indexing data for at least one type of unstructured content, wherein the indexing data is configured to facilitate access to the at least one type of unstructured content in a data storage system;
receiving unstructured content and indexing data associated with the unstructured content;
identifying structured content associated with the unstructured content based on the indexing data and the mapping information;
storing the unstructured content in the data storage system; and
linking the identified structured content with the unstructured content stored in the data storage system via the indexing data to allow access to the unstructured content stored in the data storage system via the identified structured content.

2. The method of claim 1, further comprising:
extracting the indexing data from the unstructured content.

3. The method of claim 2, wherein:
the unstructured content comprises a document image; and
extracting the indexing data from the unstructured content is performed via optical character recognition.

4. The method of claim 1, further comprising:
retrieving from the identified structured content additional indexing data; and
supplementing the initial indexing data with the additional indexing data.

5. The method of claim 1, wherein:
the identified structured content comprises a first structured content record; and
the method further comprises:
creating a second structured content record based on at least one of the first structured content record and the indexing data; and
linking the second structured content record with the unstructured content stored in the data storage system via the indexing data to allow access to the unstructured content in the data storage system via the second structured content record.

6. The method of claim 5, wherein:
the first structured content record comprises data included in a purchase order;
the second structured content comprises data included in an invoice associated with the purchase order; and
the unstructured content comprises a visual image of the purchase order.

7. The method of claim 1, wherein:
the structured content comprises a employment record for an employee; and
the unstructured content comprises a resume for the employee.

8. The method of claim 1, wherein:
the structured content comprises at least one enterprise resource planning system record; and
the unstructured content stored in the data storage system comprises an enterprise content management system record.

9. The method of claim 8, further comprising:
transferring a report generated in the enterprise resource planning system as a document to the enterprise content management system;
generating a notification to a user of the presence of the report, wherein the notification includes a link allowing the user to access the report in the enterprise content management system.

10. The method of claim 1, further comprising:
updating the indexing data for the unstructured content in response to changes in the identified structured content.

11. The method of claim 1, further comprising:
updating the indexing data based on input received from a user before storing the unstructured content in the data storage system.

12. The method of claim 1, further comprising:
receiving validation of at least one of the indexing data and the identified structured content from a user prior to storing the unstructured content in the data storage system.

13. The method of claim 1, wherein:
linking the identified structured content with the unstructured content stored in the data storage system comprises providing a hyperlink to the unstructured content in association with the identified structured content, wherein the hyperlink is configured to invoke an image viewer to view the unstructured content stored in the data storage system.

14. The method of claim 1, further comprising:
notifying a user if the identifying of the structured content is unsuccessful;
receiving modified indexing data from the user in response to the notification; and
retrying the identifying of the structured content based on the modified indexing data and the mapping information.

15. The method of claim 14, wherein:
notifying the user and receiving the modified indexing data from the user occur via an administrative console.

16. The method of claim 1, wherein:
the mapping information is received from a user via an administrative console.

17. The method of claim 1, wherein:
the linking of the identified structured content with the unstructured content occurs in response to the storing of the unstructured content.

18. A computer-readable storage medium having encoded thereon instructions to be executed by one or more processors for employing a method of coupling an enterprise resource planning system with an enterprise content management system, the method comprising:
receiving mapping information relating at least one type of structured content with indexing data for at least one type of unstructured content, wherein the indexing data is configured to facilitate access to the at least one type of unstructured content when stored in the enterprise content management system;
receiving unstructured content and indexing data associated with the unstructured content;
using the indexing data and the mapping information to identify a structured content record in the enterprise resource planning system that is associated with the unstructured content;
storing the unstructured content in the enterprise content management system as an unstructured content record; and
linking the identified structured content record to the unstructured content record via the indexing data to allow access to the unstructured content record via the identified structured content record.

19. The computer-readable storage medium of claim 18, wherein:
receiving the unstructured content and the indexing data comprises receiving the unstructured content and the indexing data from a content capture system.

20. The computer-readable storage medium of claim 18, wherein:
receiving the unstructured content and the indexing data comprises ingesting the unstructured content and the indexing data from a source other than a content capture system.

21. The computer-readable storage medium of claim 18, wherein the method further comprises:
retrieving from the identified structured content record additional indexing data; and
supplementing the initial indexing data with the additional indexing data.

22. The computer-readable storage medium of claim 18, wherein the method further comprises:
creating a second structured content record in the enterprise resource planning system based on at least one of the first structured content record and the indexing data; and
linking the second structured content record with the unstructured content record via the indexing data to allow access to the unstructured content record via the second structured content record.

23. The computer-readable storage medium of claim 18, wherein the method further comprises:
updating the indexing data based on user input before storing the unstructured content record in the electronic content management system.

24. The computer-readable storage medium of claim 18, wherein the method further comprises:
receiving validation of at least one of the indexing data and the identified structured content from a user prior to storing the unstructured content in the electronic content management system.

25. A computer system comprising one or more processors configured to execute instructions for employing a method of integrating an enterprise resource planning system with an enterprise content management system, the method comprising:
receiving mapping information relating at least one type of structured content with indexing data for at least one type of unstructured content, wherein the indexing data is configured to facilitate access to the at least one type of unstructured content in the enterprise content management system;
receiving unstructured content and metadata associated with the unstructured content;
using the metadata and the mapping information to identify a structured content record in the enterprise resource planning system that is associated with the unstructured content;
storing the unstructured content in the enterprise content management system as an unstructured content record; and
linking the identified structured content record to the unstructured content record via the metadata to facilitate user access to the unstructured content record via the identified structured content record.

26. The computer system of claim 25, wherein:
the mapping information is received from a user by way of an administrative console.
